(19) United States
(12) Patent Application Publication
(10) Pub. No.: US 2008/0319879 A1
(43) Pub. Date: Dec. 25, 2008

(54) Optimized Communication Billing Management System

(76) Inventors: Jim Carroll, Louisville, KY (US); Jeffrey Rose, Louisville, KY (US); Jenny Taylor, Louisville, KY (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 12/138,918

(22) Filed: Jun. 13, 2008

Related U.S. Application Data
(60) Provisional application No. 60/944,361, filed on Jun. 15, 2007.

(51) Int. Cl. G06F 17/00

(52) U.S. Cl. 705/30

(57) ABSTRACT

A business method is disclosed directed to attempting to saving clients money on their communications services. Specifically, billing information is obtained for a client and loaded into a database. An initial rate is determined based on this billing information, along with possibly an add on rate for add on services, which can provide a combined rate charge. At least one of the initial rate and combined rates are compared to a derived rate which is calculated by applying an algorithm to the database which applies the actual data to a plurality of rate plans provided by communications carriers to see which rate plan might provide savings for the client, if any. If savings are achieved, at least recommending if not switching to another rate plan, possibly of an other carrier.

This application claims the benefit of U.S. Provisional Patent Application No. 60/944,361 filed Jun. 15, 2007.

### FIELD OF THE INVENTION

The present invention relates to the optimization of communication services based upon historical usage patterns and communication plans available to the communications consumer. The method is particularly adapted for the cost optimization of purchased wireless communication services.

### BACKGROUND OF THE INVENTION

Today some communication expense managers are allocating actual wireless communication usage costs to client cost centers. However, these communication expense managers allocate by cost rather than by time or usage increment. Furthermore, the communication expense manager fees are not allocated down to the user and cost center level. These prior wireless telecom expense managers, have paid their customers wireless carrier bills and then charged their client for the total amounts paid allocated by client cost center plus a percentage of the client's total wireless communication expenses as a service fee. Because in most situations some communication minutes are more expensive than others, typically these expensive communication minutes, or units, are subsidizing other lower cost communication units. Accordingly, the fairest method of allocating expenses among a company's cost centers is not by the cost of the particular communication services as charged by communication service providers to the users associated with that cost center. Instead, a more useful view of communication costs is realized by developing an enterprise wide cost for communication minutes/units and to charge each cost center the unit or minute fee for each increment of communication services utilized by that cost center. In addition, the communication expense manager's fee is preferably built into the per unit or per minute charge for communication services. This presents a fairer and more accurate view of each cost center and user's actual costs to the client company.

Thus, for companies with hundreds of wireless or other communication devices, multiple divisions and cost centers, and multiple communication service providers, the present method provides those companies with an accurate map of cost of business communications.

### SUMMARY OF THE INVENTION

The process of present method begins by averaging a slice of the communication consumer client's previous communication cost billing data. This slice typically amounts to between about one and twelve months of billing information. To this billing data is added the incremental cost of providing communication expense management for the client and any desired add-on services, including reporting functionality and support services. This information is utilized to generate a derived per minute rate for the client's purchase of communication units or minutes. This derived rate is then charged to the client cost centers for each communication unit utilized by each cost center. While these steps alone would generate business benefits to both the expense manager and the communications consuming client, the communications expense manager also undertakes cost saving measures. By restructuring the client's contracts for communication services, the communication expense manager attempts to drive the actual cost of communications per minute downward. This presents an opportunity for the communications expense manager to benefit from the differential between the derived rate being charged to the client and the actual reduced rates being charged by the communication carriers. The reductions in the actual cost may also be passed along in whole or in part to the client depending upon the terms of the agreement between client and communication expense manager.

### BRIEF DESCRIPTION OF THE DRAWINGS

These precepts of the invention will be come apparent by consideration of the accompanying drawings together with the following detailed description:

FIG. 1 is an exemplary flow diagram of the calculation of the derived rate per communications unit according to an aspect of the present invention.

FIG. 2 is a flow diagram illustrating an exemplary billing and payment of funds among the communication consumer client, the communications expense manager and the communication service providers.

### DETAILED DESCRIPTION OF THE INVENTION

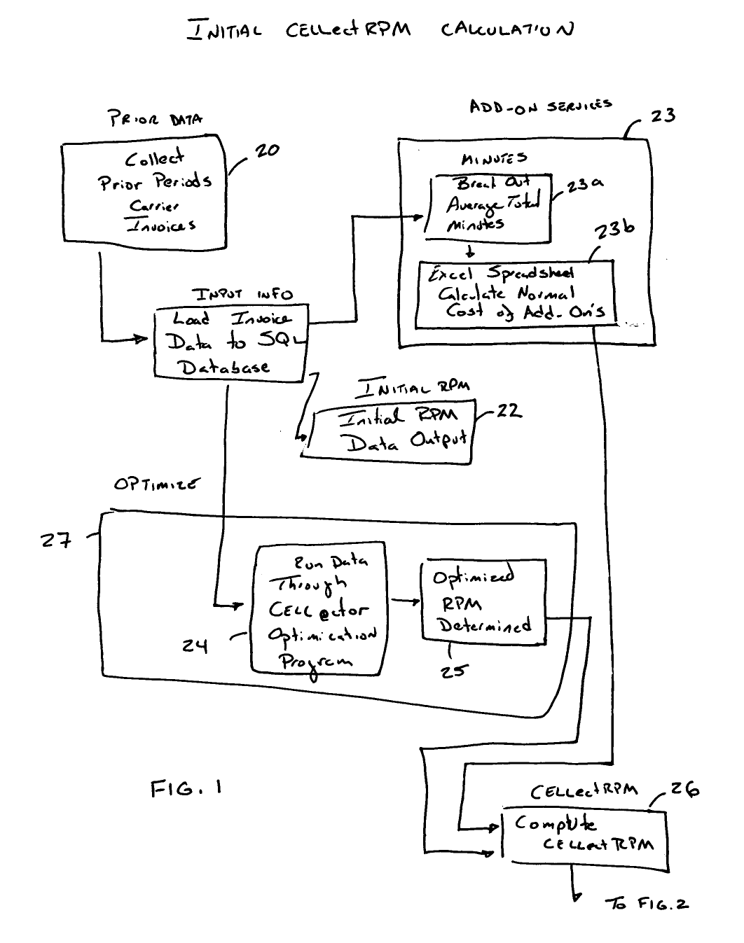

Thus, as is seen in FIG. 1, a derived rate or CELLect RPM™ calculation is performed. This calculation involves the collection of billing data from the carriers or communication services providers 20. This data is loaded into database 21 and a rate per minute cost is generated by carrier 22. In addition, the add-on services that are provided by the communications expense management service are computed 23. This computation, in the illustrated representative fashion may be performed by allocating the costs of add-on services over the average total minutes of a client 23a and calculating the result 23b. The per minute cost for add-on services 23 may include help desk and support services for client wireless devices including cell phones, as well as combination devices such as Blackberry® devices and smart phones typified by Palm Treos®. Additional add-on services may also include ordering and procurement for new services and equipment upgrades, trouble shooting, transferring numbers, service deactivations; providing device and service selection services, invoice allocation services, asset tracking, and other services priced on a request for proposal or as needed basis.

It will be understood that the rate per minute calculation 22 includes not only variable charges per minute of use but also recurring monthly charges associated with particular services and bundled minutes on a carrier's system, overages, roaming charges, long distance charges, mobile to mobile charges, taxes, standard monthly fees, pro rata charges, client approved additional features and other charges and credits. While generally it might be expected that the combination of the rate per minute calculation 22 and the per minute cost of add-on services 23 would result in the per minute charges to a client, instead, the communications expense manager takes an additional step. This step is the optimization of the client's communication charges 27. Optimization is accomplished by applying an algorithm to a database of communication plans available to the client's facilities and employees as applied to the client's actual usage patterns, in order to minimize the overall cost 24. This process determines an optimized rate per minute or optimized cost for communication services 25. If the savings through optimization are significant, the communications expense manager may offer to charge the client at a per minute rate even lower than the initial rate per minute calculation 22, or certainly lower than the combination of the initial rate per minute calculation 22 and the per minute cost of add-on services 23. This ultimate billing rate per minute or derived rate 26 is referred to as the CELLectRPM™ by BBR Wireless Management, Inc.

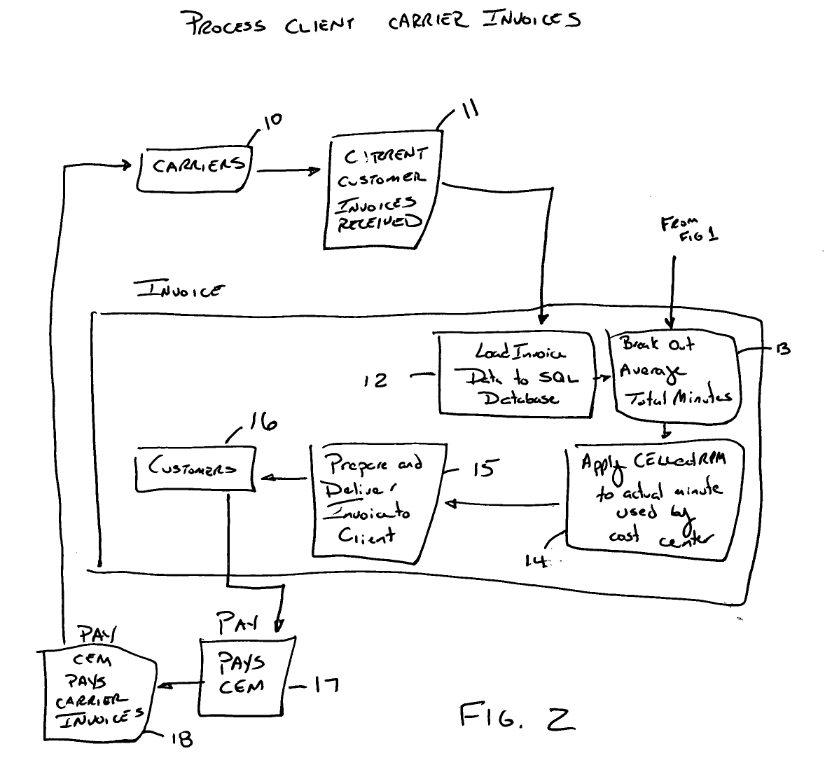

FIG. 2 then illustrates the transfer of data and funds among the communications expense manager, clients, and communication services providers. Specifically, the communication services providers 10 provide invoices 11 which are processed by the communication expense manager. This processing typically includes loading data from the invoices into a database 12, determining the number of minutes utilized by a client 13, applying the derived rate to the actual minute used by each cost center 14, delivering invoices to the client allocating communication costs by cost center 15 and preferably by communication unit by cost center. Clients 16 receive invoices and pay the communication expense manager a sum equal to the derived rate times the number of communication minutes or pays the communications service provider the face amount of the invoice 17. If client pays the communications expense manager then communication expense manager pays the invoices of communication service providers 18, generally retaining some differential as profit in compensation for the expense management and add-on services.

Numerous variations that do not part from the spirit of the invention may be utilized. For instance, rather than utilizing prior data from a client, it is be possible to estimate existing rate per minute charges by using data from similar size to companies, however, this does sacrifice some accuracy in the computations. Alternatively, add-on services could be billed to clients as a separate line item rather than included as a portion of the derived rate per minute charges. Per minute charges refer generally to communication units. While typically referred to minutes of communication in the wireless telecommunications field, these units also include data services that may be charged based upon the number of data packets or data throughput associated with communications.

While the invention has been explained with respect to a communications manager dealing with separate clients, it is also possible to practice the invention with the communication expense manager being an operating unit of the client entity for whom communications are being managed.

All publications, patents, and patent documents are incorporated by reference herein as though individually incorporated by reference. Although preferred embodiments of the present invention have been disclosed in detail herein, it will be understood that various substitutions and modifications, such as disclosed above, may be made to the disclosed embodiment described herein without departing from the scope and spirit of the present invention as recited in the appended claims.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

We claim:

1. A business method for potentially lowering at least some business expenses comprising the steps of:
a) collecting billing data for a client;
b) associated billing data with the client;
c) loading the billing data into a client database associated with the client;
d) calculating a rate per minute cost which excludes costs for add on services from the billing data in the client database;
e) calculating an add on service cost by allocating add on costs over average total minutes from the billing data in the client database;
f) optimizing using the billing data in the client database and at least one other rate plan based on client's actual usage to provide a derived rate per minute;
g) adding the initial rate per minute cost and the add on service cost to provide a per minute charge; and then
h) comparing the combined per minute charge to the derived rate per minute, and if the derived rate per minute is less than the combined per minute charge, at least recommending a switch to a rate plan corresponding to the derived rate per minute.

2. The business method of claim 1 wherein the step of calculating an initial per minute cost includes adding recurring monthly charges to the variable charges per minute and dividing by total minutes utilized.

3. The business method of claim 2 wherein the step of calculating initial per minute cost includes accounting at least some of bundled minutes, overages, roaming charges, long distance charges, mobile to mobile charges, taxes, standard monthly fees, pro rata charges, and client approved additional charges and credits to the variable charges per minute prior to dividing by the total minutes utilized.

4. The business method of claim 1 wherein the add on costs are selected from the group of help desk services, support services, ordering service costs, procurement costs for new services, procurement costs for new equipment, trouble shooting costs, number transfer fees, service deactivation fees, device selection fees, service selection fees, invoice allocation services, and asset tracking expenses.

5. The business method of claim 1 wherein the optimization step further comprising applying an algorithm to the client database and a communication plan database having a plurality of communication plans, and then selecting the lowest per minute rate as the derived rate plan.

6. The business method of claim 5 wherein a communications expense manager reviews the derived rate and the per minute charge and then procures communications services for the client through a carrier.

7. The business method of claim 6 wherein the client's services are grouped with those of other clients on an invoice from the carrier and the expense manager separates the clients services and applies the derived rate to the number of minutes utilized by the client to provide an invoice from the communications manager to the client, with the expense manager paying the carrier directly.

8. The business method of claim 7 wherein the derived rate includes a profit for the expense manager.

9. The business method of claim 6 wherein the communications expense manager evaluates the clients billing data.

10. The business method of claim 7 wherein the communications expense manager loads the clients billing data in the client database as a part of an invoice containing expenses of other clients.

11. The business method of claim 1 wherein the client is believed to be a similarly situated, but different client, than a prospective client for which at least a recommended switch is proposed.

12. The business method of claim 1 wherein the derived rate per minute includes data service charges.

13. The business method of claim 1 wherein data service charges are calculated per data throughput and tracked separately from voice minutes.

14. The business method of claim 9 wherein the expense manager is an internal operating unit of the client.

15. A business method for potentially lowering at least some business expenses comprising the steps of:
a) collecting prior periods of billing data for a client;
b) associated billing data with the client;
c) loading the billing data into a client database associated with the client by an expense manager;
d) calculating an initial rate per minute cost for voice based minute costs which excludes costs for add on services from the billing data in the client database;
e) optimizing using an algorithm applied to the billing data in the client database and at least one other rate plan based on client's actual usage to provide a derived rate per minute; and then
f) comparing at least the initial rate per minute charge to the derived rate per minute, and if the derived rate per minute is less than the combined per minute charge, at least recommending a switch to a rate plan corresponding to the derived rate per minute.

16. The business method of claim 15 wherein the initial rate per minute cost includes at least some non-minute based costs.

17. The business method of claim 16 includes adding recurring monthly charges to the variable charges per minute and dividing by total minutes utilized.

18. The business method of claim 17 further comprising the steps of calculating an add on service cost rate by allocating add on costs over average total minutes from the billing data in the client database, and adding the add on service cost rate to the initial rate per minute to compare with the derived rate.

19. The business method of claim 17 further comprising the step of calculating an add on service cost rate by allocating add on costs over average total minutes from the billing data in the client database and billing clients separately for add on services than adding in with derived rate per minute charging.

20. The business method of claim 19 wherein the expense manager provides an invoice to the client including add on service cost as a separate line item from a derived rate per minute charges.
